(19) United States
(12) Patent Application Publication
(10) Pub. No.: US 2019/0394765 A1
(43) Pub. Date: Dec. 26, 2019

(54) A WIRELESS DEVICE, A NETWORK NODE AND METHODS THEREIN FOR DETERMINING TRANSMISSION PARAMETERS FOR A TRANSMISSION IN A WIRELESS COMMUNICATIONS NETWORK

(71) Applicant: TELEFONAKTIEBOLAGET LM ERICSSON (PUBL), Stockholm (SE)

(72) Inventors: Vidit SAXENA, JÄRFÄLLA (SE); Shashi KANT, VÄLLINGBY (SE); Amit SINGH, SOLNA (SE)

(73) Assignee: TELEFONAKTIEBOLAGET LM ERICSSON (PUBL), Stockholm (SE)

(21) Appl. No.: 16/300,675

(22) PCT Filed: May 12, 2016
(86) PCT No.: PCT/SE2016/050427

§ 371 Date: Nov. 12, 2018

(51) Int. Cl. H04W 72/04

(52) U.S. Cl. CPC H04W 72/048; H04W 72/0413

(57) ABSTRACT

A method performed by a wireless device (121) for enabling determination of transmission parameters for a transmission to a network node (110) in a wireless communications network (100) is provided. The wireless device (121) obtains at least one antenna characteristic of an antenna (730) comprised in the wireless device (121). The wireless device (121) also transmits information indicating the at least one antenna characteristic to a network node (110) in the wireless communications network (100). A wireless device (121) for enabling determination of transmission parameters for a transmission to a network node (110) in a wireless communications network (100) is also provided. Furthermore, a network node (110) and a method therein for enabling determination of transmission parameters for a transmission to a wireless device (121) in a wireless communications network (100) are also provided.

### TECHNICAL FIELD

Embodiments herein relate to transmissions in a wireless communications network. In particular, embodiments herein relate to a wireless device and method therein for enabling determination of transmission parameters for a transmission to a network node in a wireless communications network, as well as, a network node and method therein for determining transmission parameters for a transmission to a wireless device in a wireless communications network.

### BACKGROUND

In today's wireless communications networks a number of different technologies are used, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible technologies for wireless communication.

A wireless communications network comprises radio base stations providing radio coverage over at least one respective geographical area forming a cell. The cell definition may also incorporate frequency bands used for transmissions, which means that two different cells may cover the same geographical area but using different frequency bands. Wireless devices, also referred to herein as User Equipments, UEs, mobile stations, and/or wireless terminals, are served in the cells by the respective radio base station and are communicating with respective radio base station. The wireless devices transmit data over an air or radio interface to the radio base stations in uplink, UL, transmissions and the radio base stations transmit data over an air or radio interface to the wireless devices in downlink, DL, transmissions.

In wireless communications networks, there is currently need to develop radio access solutions that enable large-scale deployment of low-cost devices to facilitate the so-called Internet of Things, IoT. Here, an important component is to be able to provide Machine Type Communication, MTC, devices that operate with a reduced Radio Frequency, RF, bandwidth. This is in order to reduce the complexity in the devices and thereby save costs. As such, MTC wireless devices may have a smaller bandwidth as compared to the bandwidth over which a radio base station has the ability to schedule wireless devices, i.e. the system bandwidth of the wireless communications network.

In some cases, this may also be referred to as Narrowband IoT, NB-IoT. The objective of NB-IoT is to specify a Radio Access Technology, RAT, for wireless IoT that addresses, for example, improved indoor coverage, support for massive number of low throughput devices, low delay sensitivity, ultra-low device cost, low device power consumption, and a more optimized network architecture. A wireless device according to NB-IoT is only required to support a 180 kHz RF bandwidth. Hence, both DL and UL is to allow 180 kHz RF bandwidth for wireless devices. For the DL, one way is to base the DL on 15 kHz Orthogonal Frequency Division Multiple Access, OFDMA. For the UL, one way is to base the UL on Single Carrier Frequency Division Multiple Access, SC-FDMA, with single-tone and multi-tone transmissions, with 15 kHz subcarrier spacing and an additional narrower subcarrier spacing option for single-tone transmission, i.e. currently 3.75 kHz.

NB-IOT is required to support three different modes of operation. First, a “Stand-alone operation” mode may be supported which may utilize the spectrum currently being used by GERAN systems as a replacement of one or more GSM carriers. Secondly, a “Guard band operation” mode may be supported which utilizes the unused resource blocks within a LTE carrier's guard-band. Thirdly, an “In-band operation” may be supported that utilizes resource blocks within a normal LTE carrier

Further, depending on spectrum and resource availability in the wireless communications network, multiple narrowband carriers may be defined from the wireless communications network's perspective for both DL and UL to facilitate efficient system scalability with increase in the number of IoT wireless devices. Also, scheduling between multiple narrowband carriers may be considered as well. Wireless communications networks configured in this way may also benefit from frequency diversity gains with possible wireless devices being able to retune from one narrow-band to another.

Enhancements in LTE towards supporting MTC wireless devices have been ongoing since Release 10 of the LTE standard. In Release 11 and Release 12 of the LTE standard, a number of features related to MTC were specified that target similar goals as NB-IoT as described above. Furthermore, the new category for wireless device, denoted Cat-0, for low complexity wireless devices was introduced in Release 12 of the LTE standard. In Release 13 of the LTE standard, further enhancements have been introduced to support MTC operation, commonly referred to as further enhanced MTC, feMTC, which aims to further reducing the complexity of the wireless devices. The feMTC features have been used to specify a new category for wireless devices, Cat-M1, in Release 13 of the LTE standard.

A wireless device supporting feMTC is only required to support a RF bandwidth of 1.4 MHz in the UL, as well as, the DL. This may be compared to the 20 MHz RF bandwidth that is supported by legacy LTE wireless devices. This allows for significant cost and complexity savings. However, operation within any part of a larger system bandwidth, such as, e.g. 10 MHz, is allowed.

The LTE system bandwidth is divided into non-overlapping narrow-bands spanning six Physical Resource Blocks, PRBs, each to simplify resource allocation for low-cost wireless device at both the DL and the UL. A wireless device that supports feMTC may be scheduled over any narrowband where it is able to transmit and/or receive data transmission by retuning its centre frequency appropriately. This retuning will, however, incur a retuning guard interval of up to two OFDM symbols. FIG. 1 illustrates how a wireless device according to feMTC may operate in different part of the LTE system bandwidth by retuning its centre frequency.

It should be noted that the wireless device according to feMTC is not required to support those legacy downlink channels that span larger than 6 PRBs, such as, for example, a Physical Downlink Control Channel, PDCCH, a Physical Hybrid ARQ Indicator Channel, PHICH, and a Physical Control Format Indicator Channel, PCFICH. For downlink control information, a downlink control channel M-PDCCH has been introduced based on EPDCCH. The downlink control channel M-PDCCH that also supports mapping over 6 PRBs. The downlink control channel M-PDCCH also includes common and UE-specific search spaces and is used to carry downlink control information, uplink scheduling grants, as well as, uplink HARQ feedback.

In LTE UL, Sounding Reference Signals, SRS, are commonly used to obtain UL channel information over a wide bandwidth. This may also be referred to as UL channel sounding. The channel information from SRS is used, among other things, for determining the optimal set of PRBs over which the wireless device is to be scheduled. A radio base station may configure periodic SRS transmissions at an interval of, for example, 2, 5, or 16 ms. Additionally, the radio base station may also request aperiodic or one-time SRS transmissions from one or more wireless devices by signalling over the downlink control channel.

The UL channel characteristics over a wide bandwidth are obtained by configuring the SRS transmissions. The SRS transmission may be configured to occupy the system bandwidth, allowing the radio base station to sound the entire channel with a single SRS transmission. However, due to the limited transmit power of wireless devices, such wideband SRS transmissions may have a poor Power Spectral Density, PSD, property, and consequently noisy channel estimates at the radio base station.

In order to provide for an improved PSD property for UL channel sounding, the SRS transmissions may also be configured with a smaller bandwidth and configured to perform frequency hopping across the system bandwidth. FIG. 2 illustrates both these SRS configurations; non-frequency hopping SRS transmissions are shown in the upper part of FIG. 2 and the frequency hopping SRS transmissions are shown in the lower part of FIG. 2. The frequency hopping SRS transmission may, for example, be configured with a bandwidth granularity of 4 PRBs.

It is thus clear that wireless devices that have a smaller bandwidth than the system bandwidth is not able to support wideband SRS transmissions. For example, wireless devices supporting NB-IoT is not able to support legacy SRS transmission in any configuration because of their RF bandwidth of one PRB. The wireless devices that supports feMTC are only able to support appropriately configured SRS transmission in small or medium coverage enhancement, i.e. the so-called “mode A” operation.

### SUMMARY

It is an object of embodiments herein to improve transmissions for wireless devices in a wireless communication network.

According to a first aspect of embodiments herein, the object is achieved by a method performed by a wireless device for enabling determination of transmission parameters for a transmission to a network node in a wireless communications network. The wireless device obtains at least one antenna characteristic of an antenna comprised in the wireless device. The wireless device also transmits information indicating the at least one antenna characteristic to a network node in the wireless communications network.

According to a second aspect of embodiments herein, the object is achieved by a wireless device for enabling determination of transmission parameters for a transmission to a network node in a wireless communications network. The wireless device is configured to obtain at least one antenna characteristic of an antenna comprised in the wireless device. The wireless device is also configured to transmit information indicating the at least one antenna characteristic to a network node in the wireless communications network.

According to a third aspect of embodiments herein, the object is achieved by a method performed by a network node for determining transmission parameters for a transmission to a wireless device in a wireless communications network. The network node obtains information indicating at least one antenna characteristic of the wireless device. Also, the network node performs the transmission to the wireless device based on the information indicating the at least one antenna characteristic of the wireless device.

According to a fourth aspect of embodiments herein, the object is achieved by a network node for determining transmission parameters for a transmission to a wireless device in a wireless communications network. The network node is configured to obtain information indicating at least one antenna characteristic of the wireless device. The network node is also configured to perform the transmission to the wireless device based on the information indicating the at least one antenna characteristic of the wireless device.

By having the wireless device providing the network node with antenna characteristics, the network node is enabled to perform transmissions to the wireless device based on the provided antenna characteristics of the wireless device. This means that the spectral efficiency of the transmission may be improved and that the power consumption of the transmission may be reduced, since frequency selective scheduling and link adaptation for the transmission may be adapted by the network node with regards to the provided antenna characteristics of the wireless device.

Hence, transmissions for wireless devices in a wireless communication network is improved.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a schematic overview depicting a retuning of a centre frequency by a wireless device within a LTE system bandwidth,

FIG. 2 is a schematic overview depicting channel estimation using SRS transmissions,

FIG. 3 illustrates an antenna and a diagram indicating the efficiency of the antenna around its centre frequency,

FIG. 4 is a schematic block diagram illustrating embodiments of a network node and a wireless device in a wireless communications network,

FIG. 5 is a flowchart depicting embodiments of a method in a wireless device,

FIG. 6 is a flowchart depicting embodiments of a method in a network node,

FIG. 7 is a block diagram depicting embodiments of a wireless device,

FIG. 8 is a block diagram depicting embodiments of a network node.

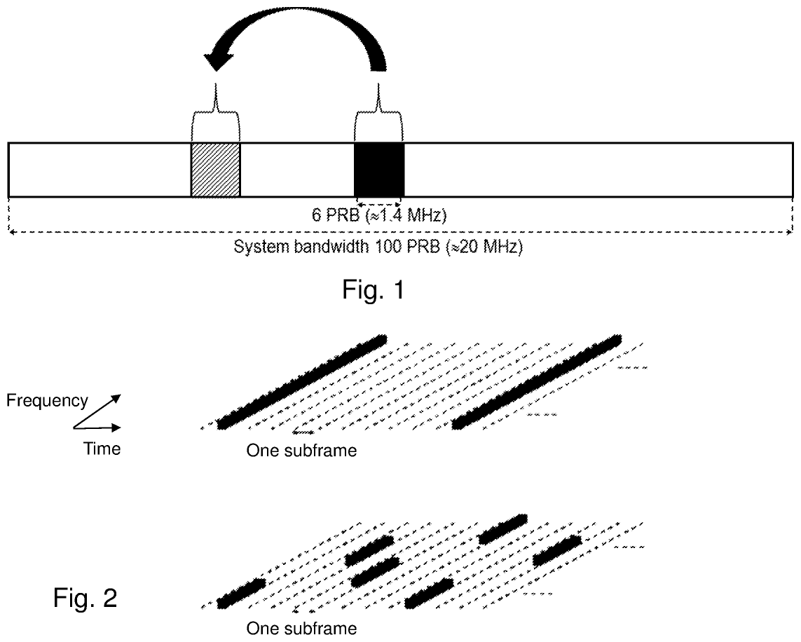

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

As part of understanding and developing the embodiments described herein, some issues will first be identified and discussed in more detail.

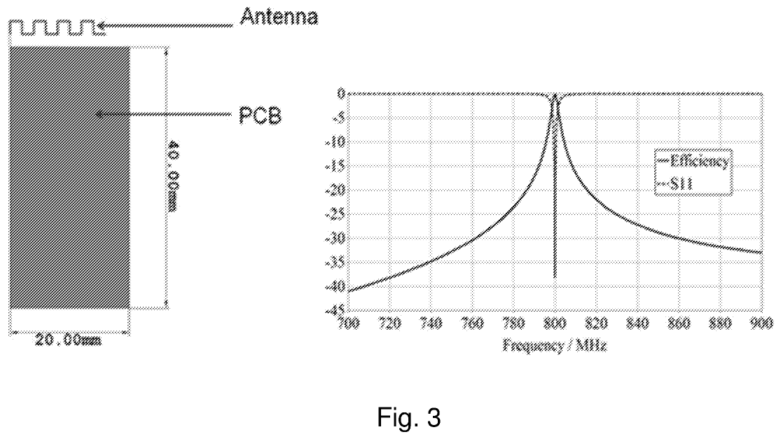

Normally, wireless devices employ antenna matching networks to sufficiently match the antenna of the wireless device across the system bandwidth. However, such antenna matching networks often constitute a significant fraction of the cost of the transceiver of the wireless device. Thus, in order to reduce cost for wireless devices, the antenna matching networks of the wireless devices might be extremely simplified or even discarded altogether. Additionally, form factor requirements may also dictate the volume of the antenna in the wireless device, i.e. the antenna performance and bandwidth of a wireless device may also be fundamentally limited due to size constraints of the antenna. This means that such wireless devices will likely comprise sub-optimal antennas that are well-matched only over a relatively narrow bandwidth. This is illustrated in FIG. 3.

FIG. 3 shows an antenna of a low-complexity wireless device and a diagram indicating the efficiency of the antenna around its centre frequency. According to the diagram, it is noted that the antenna reflection coefficient, i.e. a measure of the antenna efficiency, is not constant over the wide system bandwidth, for example, a LTE system with a 20 MHz system bandwidth. Here, it should be noted that the antenna efficiency degrades rapidly in log domain from the reference point at 800 MHz and may fall nearly −18 dB at 790 MHz and 810 MHz. Thus, the antenna efficiency may vary by as much as 20 dB over a 20 MHz system bandwidth. This implies that that the antenna of the low-complexity wireless device has a significantly poor performance over large sections of the system bandwidth.

Similarly, for example, in the case of low-complexity wireless devices, i.e. LC UEs, according to Release 13 of the LTE standard, the antennas of the wireless devices may be well-matched only over a few MHz of the system bandwidth. According to another example, in case of wireless devices according to NB-IoT, i.e. NB-IoT UEs, the antennas may be well-matched only over a few hundred kHz of the system bandwidth. If this is not considered in a wireless communications network when transmitting to the wireless device, it may lead to scheduling and link adaption for such transmissions being sub-optimal in terms of their antenna matching performance.

Furthermore, conventionally, the effect of the antenna response at a wireless device may be implicitly understood by a network node when analysing the channel using downlink and uplink reference signals from the wireless device. However, this may be very inefficient for a wireless device with a small or narrow bandwidth, since it means that it has to provide Channel State Information, CSI, reports over the entire system bandwidth. For example, the wireless device may perform SRS transmissions utilizing frequency hopping across the entire system bandwidth. This will occupy a large amount of subframes and may be unsuitable from a processing perspective as well.

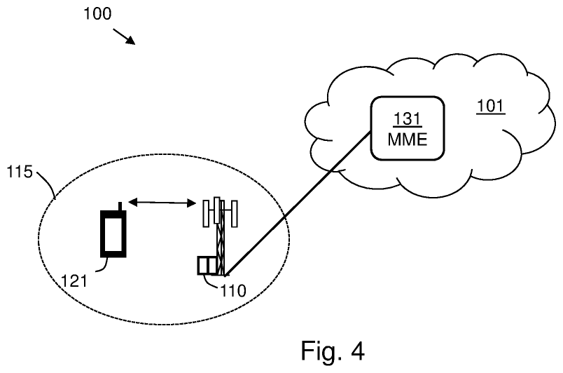

These issues are addressed by the embodiments described herein with reference to FIGS. 4-8 by having the wireless device providing the network node with its antenna characteristics. This will, for example, improve scheduling and link adaptation for wireless devices with a narrow bandwidth or a sub-optimal antenna matching over the system bandwidth. The latter may, for example, be the case when having a wireless device with a regular RF bandwidth operating in a large broadband system bandwidth, such as, e.g. a regular LTE wireless device operating in an LTE system with about 100 MHz bandwidth.

FIG. 4 depicts a wireless communications network 100 in which embodiments herein may be implemented. The wireless communications network 100 may be a radio communications network, such as, e.g. LTE, WCDMA, GSM, 3GPP cellular network, or any other cellular network or system. The wireless communications network 100 may also, for example, be referred to as a cellular network or system or a telecommunications network.

The wireless communications network 100 comprises a radio base station, which is referred to herein as a network node 110. The network node 110 is a network unit capable to serve wireless devices which are located within its radio coverage area, i.e. cell 115. The network node 110 may e.g. be an eNB, eNodeB, or a Home Node B, a Home eNode B, femto Base Station (BS), pico BS or any other network unit capable of serving a wireless device or a machine type communication device in the wireless communications network 100. The network node 110 may be connected to a Mobility Management Entity, MME 131. The MME 131 may be located in a core network 101 of the wireless communications network 100.

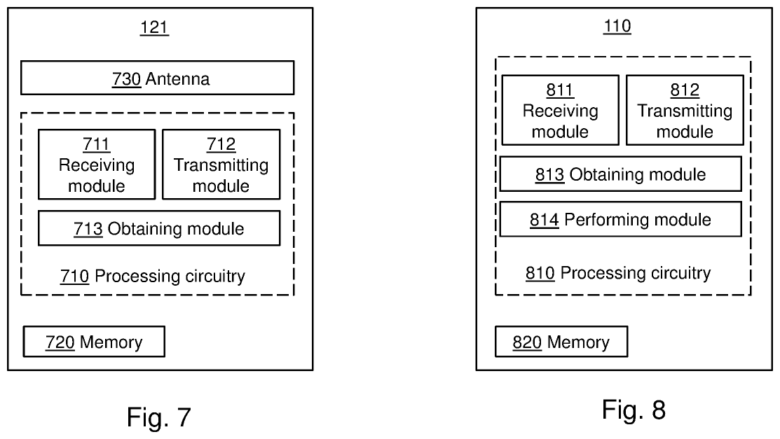

A wireless device 121 is shown located within the cell 115 which is served by the network node 110. The wireless device 121 is configured to communicate within the wireless communications system 100 via the network node 110 over a radio link when the wireless device 121 is present in the cell 115. The wireless device 121 may be capable of operating or performing measurements in one or more frequencies, carrier frequencies, component carriers or frequency bands. The wireless device 121 may also be interchangeably referred to as a mobile station, a terminal, a wireless terminal, and/or a user equipment, UE. It may here also be pointed out that these terms as used herein should be understood by the skilled in the art as non-limiting terms comprising any wireless device or node equipped with a radio interface allowing for receiving and transmitting signals to the network node 110. For example, the wireless device 121 may, for example, be a mobile terminal or a wireless terminal, a mobile, a mobile phone, a sensor, a computer such as for example a laptop, a Personal Digital Assistant (PDA) or a tablet computer with wireless capability, a device or terminal using Machine Type Communication (MTC), a Machine-to-Machine (M2M) communication device, a wireless device used for Device-to-Device (D2D) communication, a fixed or mobile relay or relay node, a device equipped with a wireless interface, such as a printer or a file storage device, or any other radio network unit capable of communicating over a radio link in a wireless communications system 100. The wireless device 121 may comprise one or more antennas, such as, e.g. the antenna 730 shown in FIG. 7.

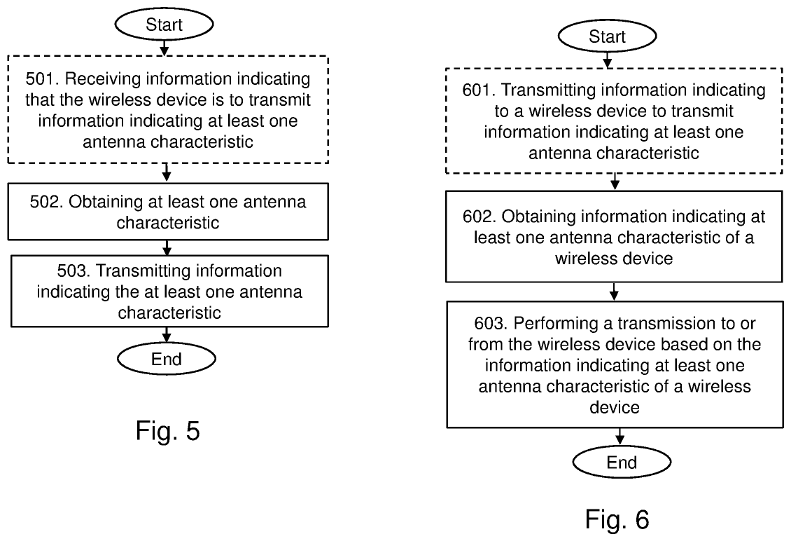

Embodiments of the network node 110, the wireless device 121 and methods therein will be described in more detail below with reference to FIGS. 5-8.

Example of embodiments of a method performed by a wireless device 121 for enabling determination of transmission parameters for a transmission to a network node 110 in a wireless communications network 100 will now be described with reference to the flowchart depicted in FIG. 5. FIG. 5 is an illustrated example of actions or operations which may be taken by a wireless device 121 in the wireless communication network 100. The method may comprise the following actions.

Action 501

In this optional action, the wireless device 121 may receive information indicating that the wireless device 121 is to transmit information indicating at least one antenna characteristic to a network node 110 in the wireless communications network 100. This means that the network node 110 may request the wireless device 121 to provide the at least one antenna characteristic. This may be advantageous when, for example, the wireless device 121 is able to match its antenna to more than one frequency band or has a set of different antenna matching configurations.

This may, for example, be performed when a change in at least one antenna characteristic of the wireless device 121 is expected or has been detected by the network node 110. One example of such a change may be that the wireless device 121 has reported a high temperature of the antenna which may affect at least one antenna characteristic of the wireless device 121. Another example may be that a periodical request has been triggered in the network node 110, or that the network node 110 has received an indication that there has been a change in at least one antenna characteristic of the antenna of the wireless device 121. However, it should also be noted that normally the antenna characteristics of the wireless device 121 is not expected to change significantly during the lifetime of its connection with the network node 110.

Action 502

The wireless device 121 obtains information indicating at least one antenna characteristic of an antenna 730 comprised in the wireless device 121. The wireless device 121 may obtain the information indicating the at least one antenna characteristic of the antenna 730 by, for example, retrieving the information indicating the at least one antenna characteristic of the antenna 730 from a storage device or memory within the wireless device 121. In some embodiments, this may be performed in response to receiving the information in Action 501.

In some embodiments, the information indicating the at least one antenna characteristic may comprise a parameter of the antenna 730 that indicates at least one of: a gain of the antenna 730, an impedance of the antenna 730, a radiation pattern of the antenna 730, a beam width of the antenna 730, and a polarization of the antenna 730. Some of these antenna parameters may also be commonly referred to as scattering parameters, or S-parameters, of the antenna 730. These antenna parameters may depend on the geometry, form and material of the antenna 730, and may also be frequency-dependent. In some embodiments, the at least one antenna characteristic may also comprise a resonance frequency of the antenna 730, a 3-dB bandwidth of the antenna 730, a 10-dB bandwidth of the antenna 730, a return loss parameter of the antenna 730, or a class associated with the antenna 730. It should be noted that any combination of the above mentioned parameters may be comprised in the at least one antenna characteristic obtained by the wireless device 121.

According to some embodiments, the resonance frequency of the antenna 730 may be configured to correspond to the centre frequency of the system bandwidth in the wireless communications network 100. Here, the network node 110 may assume that the antenna 730 of the wireless device 121 is always matched to the centre of the system bandwidth, which advantageously then may reduce the signalling requirements to communicate the at least one antenna characteristics of the antenna 730 of the wireless device 121 in Action 503. However, this may also constrain the frequency domain scheduling, especially in case of a large number of served wireless devices.

Optionally, the resonance frequency of the antenna 730 may be configured to correspond to a determined frequency from of a set of determined frequencies within the system bandwidth of the wireless communications network 100. This means that the antenna 730 of the wireless device 121 may be matched to one, or more, out of a set of pre-defined or determined frequencies within the system bandwidth. This would advantageously result in a reasonable signalling overhead to communicate the at least one antenna characteristics of the antenna 730 of the wireless device 121 in Action 503, while distributing the optimally scheduled resources in wireless communications network 100 for scheduling uplink and downlink transmissions.

Action 503

After obtaining the at least one antenna characteristic of the antenna 730 in Action 502, the wireless device 121 transmits the information indicating the at least one antenna characteristic to a network node 110 in the wireless communications network 100. In some embodiments, the transmission may be performed as part of a connection setup procedure of the wireless device 121 in the wireless communications network 100. For example, in case the antenna 730 of the wireless device 121 is associated with a certain antenna class, the wireless device 121 may signal its antenna class as part of its connection setup procedure. Here, different antenna class may be determined, in combination or independently from other features in the wireless device 121, to indicate different antenna characteristics in network node 110. Optionally, the transmission may be performed as part of a random access procedure of the wireless device 121 in the wireless communications network 100. For example, the wireless device 121 may select one out of many available random access preambles during the random access procedure. In this case, the choice of a preamble may be specified to indicate different antenna characteristics in the network node 110.

In some cases, since the antenna characteristics of the wireless device 121 is not expected to change significantly during the lifetime of its connection with the network node 110, the wireless device 121 may explicitly transmit the information indicating the at least one antenna characteristic without incurring a significant transmission overhead. For example, the wireless device 121 may configure additional bits to indicate different antenna characteristics to the network node 110 during, for example, a random access procedure.

It should also be noted that, according to some embodiments, the obtaining of the information indicating at least one antenna characteristic of an antenna 730 in Action 502 and/or the transmitting of the information indicating the at least one antenna characteristic in Action 503 may be performed in response to detecting a change in at least one antenna characteristic of the antenna 730. This means that the wireless device 121 may determine that a change in at least one antenna characteristic of the antenna 730 in the wireless device 121 has occurred and therefore proceed to update the network node 110 with this information.

Example of embodiments of a method performed by a network node 110 for determining transmission parameters for a transmission to a wireless device 121 in a wireless communications network 100 will now be described with reference to the flowchart depicted in FIG. 6. FIG. 6 is an illustrated example of actions or operations which may be taken by a network node 110 in the wireless communication network 100. The method may comprise the following actions.

Action 601

Optionally, the network node 110 may first transmit information indicating that the wireless device 121 is to transmit information indicating at least one antenna characteristic to the wireless device 121 in the wireless communications network 100. This means that the network node 110 may request the wireless device 121 to provide the at least one antenna characteristic.

Action 602

The network node 110 obtains information indicating at least one antenna characteristic of the wireless device 121. In some embodiments, the network node 110 may receive the information indicating at least one antenna characteristic of the wireless device 121 from the wireless device 121.

In some embodiments, the network node 110 may perform a channel estimation over the complete system bandwidth in the wireless communications network 100, and then determine information indicating the at least one antenna characteristic of the wireless device 121 based on the performed channel estimation. For example, in case the radio channel over a wide bandwidth is approximately known by the network node 110, e.g. a nearly-flat radio channel, then the network node 110 may indicate to the wireless device 121 to perform a channel sounding over the wide bandwidth, e.g. the whole system bandwidth. This may be performed by using for e.g. periodic SRS-like transmissions. In this case, the channel estimations at the network node 110 will represent a combination of the radio channel response and the antenna characteristics of the antenna 730 of the wireless device 121 This means that the network node 110 may use the approximately known channel, such as, e.g. use the assumption of a nearly-flat radio channel, to derive the at least one antenna characteristic of the wireless device 121.

In some embodiments, the network node 110 may retrieve the information indicating the at least one antenna characteristic of the wireless device 121 from another network node 131 in the wireless communications network 100. Since the at least one antenna characteristic of the wireless device 121 are expected to be fairly constant over the lifetime of the wireless device 121, the at least one antenna characteristic of the wireless device 121 may, for example, be stored in a persistent location in the wireless communications network 100. For example, the at least one antenna characteristic of the wireless device 121 may be stored in data storage or server within the core network 101. In this case, the the at least one antenna characteristic of the wireless device 121 may be provided to the network node 110 along with other information, such as, e.g. subscription information, etc., of the wireless device 121. Optionally, the at least one antenna characteristic of the wireless device 121 may be stored within the MME 131 in the wireless communications network 100. In this case, the at least one antenna characteristic of the wireless device 121 may be provided to the network node 110 as a part of context signalling for the wireless device 121 upon going into an active state.

In some embodiments, the network node 110 may store the information indicating the at least one antenna characteristic of the wireless device 121 via another network node, such as, e.g. the MME 131, in the wireless communications network 100. This means that the network node 110 may also store its information concerning the at least one antenna characteristic of the wireless device 121 at a central location in the wireless communications network 100.

Action 603

After obtaining the information indicating at least one antenna characteristic in Action 602, the network node 110 may perform the transmission to the wireless device 121 based on the information indicating the at least one antenna characteristic of the wireless device 121. By having access to the at least one antenna characteristic of the wireless device 121, the network node 110 is able to match the transmission to the wireless device 121 based on the at least one antenna characteristic of the wireless device 121. Hence, the network node 110 may match the transmission to the wireless device 121 by performing frequency selective scheduling and link adaptation with regards to the at least one antenna characteristic of the wireless device 121.

In some embodiments, the network node 110 may schedule the transmission to the wireless device 121 on at least one frequency carrier based on the information indicating the at least one antenna characteristic of the wireless device 121.

In this case, according to some embodiments, the network node 110 may determine, based on the information indicating the at least one antenna characteristic of the wireless device 121, the at least one frequency carrier such that it spans over a resonance frequency of the antenna 730. Optionally, in this case, the network node 110 may determine, based on the information indicating the at least one antenna characteristic of the wireless device 121, the at least one frequency carrier in relation to a resonance frequency of the antenna 730 such that the antenna efficiency of the antenna 730 for the transmission to the wireless device 121 is above a determined threshold. This means that the network node 110 may be set to always attempt to schedule the wireless device 121 close to the resonance frequency of its antenna 730 in order to minimize the expected pathloss of the transmission. This may be particular advantageous when the radio channel over a wide bandwidth is not known by the network node 110 or explicitly estimated. For example, several NB-IoT carriers may be deployed within an LTE system bandwidth and within the guard-band of the LTE system. Here, the network node 110 may schedule the wireless device 121, e.g. in case the wireless device 121 is an NB-IoT device, on a carrier that spans the resonance frequency of the antenna 730 of the wireless device 121. According to another example, in case the wireless device 121 is a feMTC device, the network node 110 may schedule uplink and/or downlink data transmissions within, for example, the 3-dB bandwidth of the antenna 730 of the wireless device 121.

In some embodiments, the network node 110 may adapt a radio link used for the transmission to the wireless device 121 based on the information indicating the at least one antenna characteristic of the wireless device 121. In this case, according to some embodiments, the network node 110 may adapt the radio link by selecting at least one of the following parameters for the transmission: a transmit power, a transport block size, a coding scheme, a modulation order, a precoding matrix, and a number of spatial layers. For example, the network node 110 may take measures or actions in order to ensure a similar coverage across an entire wide bandwidth when the wireless device 121 is required to frequency hop across a wide bandwidth. This may also be particular advantageous when the radio channel over a wide bandwidth is not known by the network node 110 or explicitly estimated. For example, the network node 110 may adjust the transmit power levels of the transmission in order to compensate for the expected changes in pathloss from the non-flat antenna response of the antenna 730 of the wireless device 121 across the entire large bandwidth. Similarly, the network node 110 may adjust the transport block size, the coding scheme, the number of repetitions, etc., in order to offset the changes in antenna response of the antenna 730 of the wireless device 121 across the entire large bandwidth.

To perform the method actions in the wireless device 121 for enabling determination of transmission parameters for a transmission to a network node 110 in a wireless communications network 100 may comprise the following arrangement depicted in FIG. 7. FIG. 7 shows a schematic block diagram of embodiments of a wireless device 121. The embodiments of the wireless device 121 described herein may be considered as independent embodiments or may be considered in any combination with each other to describe non-limiting examples of the example embodiments described herein.

The wireless device 121 may comprise processing circuitry 710, a memory 720 and at least one antenna, such as, the antenna 730. The processing circuitry 1110 may also comprise a receiving module 711 and a transmitting module 712. The receiving module 711 and the transmitting module 712 may comprise RF circuitry and baseband processing circuitry enabling the wireless device 121 to transmit and receive data transmissions in the wireless communications network 100. In particular embodiments, some or all of the functionality described above as being performed by the wireless device 121 may be provided by the processing circuitry 710 executing instructions stored on a computer-readable medium, such as the memory 720 shown in FIG. 7. Alternative embodiments of the wireless device 121 may comprise additional components, such as, the obtaining module 713, being responsible for providing its respective functionality necessary to support the embodiments described herein.

The wireless device 121 or processing circuitry 710 is configured to, or may comprise the obtaining module 713 configured to, obtain information indicating at least one antenna characteristic of an antenna 730 comprised in the wireless device 121. Also, the wireless device 121 or processing circuitry 710 is configured to, or may comprise the transmitting module 712 configured to, transmit the information indicating the at least one antenna characteristic to a network node 110 in the wireless communications network 100.

In some embodiments, the information indicating the at least one antenna characteristic comprise at least one of: a parameter of the antenna 730 that indicates at least one of: a gain of the antenna 730, an impedance of the antenna 730, a radiation pattern of the antenna 730, a beam width of the antenna 730, and a polarization of the antenna 730; a resonance frequency of the antenna 730; a 3-dB bandwidth of the antenna 730; a 10-dB bandwidth of the antenna 730; a return loss parameter of the antenna 730; and a class associated with the antenna 730.

In some embodiments, the wireless device 121 or processing circuitry 710 may further be configured to, or may comprise the transmitting module 712 being configured to, transmit the information as part of a connection setup procedure of the wireless device 121 in the wireless communications network 100. Optionally, the wireless device 121 or processing circuitry 710 may further be configured to, or may comprise the transmitting module 712 being configured to, transmit the information as part of a random access procedure of the wireless device 121 in the wireless communications network 100.

In some embodiments, the resonance frequency of the antenna 730 is configured to correspond to the centre frequency of the system bandwidth in the wireless communications network 100. In some embodiments, the resonance frequency of the antenna 730 is configured to correspond to a determined frequency from of a set of determined frequencies within the system bandwidth of the wireless communications network 100.

In some embodiments, the wireless device 121 or processing circuitry 710 may further be configured to, or may comprise the receiving module 711 being configured to, receive information indicating that the wireless device 121 is to transmit information indicating at least one antenna characteristic to a network node 110 in the wireless communications network 100.

In some embodiments, the wireless device 121 or processing circuitry 710 may further be configured to, or may comprise the obtaining module 711 and/or the transmitting module 712 being configured to, obtain and/or transmit the information indicating at least one antenna characteristic in response to detecting a change in at least one antenna characteristic of the antenna 730.

Furthermore, the embodiments for enabling determination of transmission parameters for a transmission to a network node 110 in a wireless communications network 100 described above may be implemented through one or more processors, such as the processing circuitry 710 in the wireless device 121 depicted in FIG. 7, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 710 in the wireless device 121. The computer program code may e.g. be provided as pure program code in the wireless device 121 or on a server and downloaded to the wireless device 121.

Those skilled in the art will also appreciate that the processing circuitry 710 and the memory 720 described above may refer to a combination of analog and digital circuits, and/or one or more processors configured with software and/or firmware, e.g. stored in a memory, that when executed by the one or more processors such as the processing circuitry 720 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

To perform the method actions in the network node 110 for determining transmission parameters for a transmission to a wireless device 121 in a wireless communications network 100 may comprise the following arrangement depicted in FIG. 8. FIG. 8 shows a schematic block diagram of embodiments of a network node 110. The embodiments of the network node 110 described herein may be considered as independent embodiments or may be considered in any combination with each other to describe non-limiting examples of the example embodiments described herein.

The network node 110 may comprise a processing circuitry 810, a memory 820 and at least one antenna (not shown). The processing circuitry 810 may comprise a receiving module 811 and a transmitting module 812. The receiving module 811 and the transmitting module 812 may comprise RF circuitry and baseband processing circuitry enabling the network node 110 to transmit and receive data transmissions in the wireless communications network 100. In particular embodiments, some or all of the functionality described above as being performed by the network node 110 may be provided by the processing circuitry 810 executing instructions stored on a computer-readable medium, such as the memory 820 shown in FIG. 8. Alternative embodiments of the wireless device 121 may comprise additional components, such as, the obtaining module 813 and the performing module 814, each being responsible for providing its respective functionality necessary to support the embodiments described herein.

The network node 110 or processing circuitry 810 is configured to, or may comprise the obtaining module 813 configured to, obtain information indicating at least one antenna characteristic of the wireless device 121. Also, the network node 110 or processing circuitry 810 is configured to, or may comprise the performing module 814 configured to, perform the transmission to the wireless device 121 based on the information indicating the at least one antenna characteristic of the wireless device 121.

In some embodiments, the network node 110 or processing circuitry 810 may be configured to, or may comprise the performing module 811 being configured to, perform the transmission by scheduling the transmission to the wireless device 121 on at least one frequency carrier based on the information indicating the at least one antenna characteristic of the wireless device 121. In this case, the network node 110 or processing circuitry 810 may be configured to, or may comprise the performing module 811 being configured to, determine, based on the information indicating the at least one antenna characteristic of the wireless device 121, the at least one frequency carrier such that it spans over a resonance frequency of the antenna 730. Optionally, the network node 110 or processing circuitry 810 may be configured to, or may comprise the performing module 811 being configured to, determine, based on the information indicating the at least one antenna characteristic of the wireless device 121, the at least one frequency carrier in relation to a resonance frequency of the antenna 730 such that the antenna efficiency of the antenna 730 for the transmission to the wireless device 121 is above a determined threshold.

In some embodiments, the network node 110 or processing circuitry 810 may be configured to, or may comprise the performing module 811 being configured to, perform the transmission by adapting a radio link used for the transmission to the wireless device 121 based on the information indicating the at least one antenna characteristic of the wireless device 121. In this case, the network node 110 or processing circuitry 810 may be configured to, or may comprise the performing module 811 being configured to, adapt the radio link by selecting at least one of the following parameters for the transmission: a transmit power, a transport block size, a coding scheme, a modulation order, a precoding matrix, and a number of spatial layers.

In some embodiments, the network node 110 or processing circuitry 810 may be configured to, or may comprise the obtaining module 813 configured to, obtain the information by performing a channel estimation over the complete system bandwidth in the wireless communications network 100. In this case, the network node 110 or processing circuitry 810 may be configured to, or may comprise the obtaining module 813 configured to, determine the at least one antenna characteristic of the wireless device 121 based on the performed channel estimation. Optionally, according to some embodiments, the network node 110 or processing circuitry 810 may be configured to, or may comprise the obtaining module 813 configured to, obtain the information by retrieving the information indicating the at least one antenna characteristic of the wireless device 121 from another network node 131 in the wireless communications network 100. According to another option, in some embodiments, the network node 110 or processing circuitry 810 may be configured to, or may comprise the obtaining module 813 configured to, obtain the information by receiving the information indicating at least one antenna characteristic of the wireless device 121 from the wireless device 121.

In some embodiments, the network node 110 or processing circuitry 810 may be configured to store the information indicating at least one antenna characteristic of the wireless device 121 via another network node, such as, e.g. the MME 131, in the wireless communications network 100. In some embodiments, the network node 110 or processing circuitry 810 may be configured to, or may comprise the transmitting module 812 being configured to, transmit information indicating that the wireless device 121 is to transmit information indicating the at least one antenna characteristic to the wireless device 121 in the wireless communications network 100.

Furthermore, the embodiments for determining transmission parameters for a transmission to a wireless device 121 in a wireless communications network 100 described above may be implemented through one or more processors, such as the processing circuitry 810 in the network node 110 depicted in FIG. 8, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 810 in the network node 110. The computer program code may e.g. be provided as pure program code in the network node 110 or on a server and downloaded to the network node 110.

Those skilled in the art will also appreciate that the processing circuitry 810 and the memory 820 described above may refer to a combination of analog and digital circuits, and/or one or more processors configured with software and/or firmware, e.g. stored in a memory, that when executed by the one or more processors such as the processing circuitry 820 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described preferred embodiments. Various alternatives, modifications and equivalents may be used. Therefore, the above embodiments should not be construed as limiting.

### Abbreviations

### 3GPP Third Generation Partnership Project

### UMTS Universal Mobile Telecommunications System

### GSM Global System for Mobile Communications

### WCDMA Wideband Code Division Multiple Access

### HSPA High Speed Packet Access

### LTE Long Term Evolution

### RAN Radio Access Network

UTRAN UMTS terrestrial RAN

### E-UTRAN Evolved Universal Terrestrial Radio Access Network

### UE User Equipment

### NB-LTE Narrowband LTE

### NB-IoT Narrowband IoT

### IoT Internet of Things

### RAT Radio Access Technology

### MTC Machine Type Communications

### OFDM Orthogonal Frequency Division Multiplexing

feMTC further enhanced MTC

### SRS Sounding Reference Signals

1. A method performed by a wireless device (121) for enabling determination of transmission parameters for a transmission to a network node (110) in a wireless communications network (100), the method comprising
obtaining (502) information indicating at least one antenna characteristic of an antenna (730) comprised in the wireless device (121); and
transmitting (503) the information indicating the at least one antenna characteristic to a network node (110) in the wireless communications network (100).

2. The method according to claim 1, wherein the information indicating the at least one antenna characteristic comprise at least one of:
a parameter of the antenna (730) that indicates at least one of: a gain of the antenna (730), an impedance of the antenna (730), a radiation pattern of the antenna (730), a beam width of the antenna (730), and a polarization of the antenna (730);
a resonance frequency of the antenna (730);
a 3-dB bandwidth of the antenna (730);
a 10-dB bandwidth of the antenna (730);
a return loss parameter of the antenna (730); and
a class associated with the antenna (730).

3. The method according to claim 1 or 2, wherein the transmitting (503) is performed as part of a connection setup procedure of the wireless device (121) in the wireless communications network (100).

4. The method according to claim 1 or 2, wherein the transmitting (503) is performed as part of a random access procedure of the wireless device (121) in the wireless communications network (100).

5. The method according to any of claims 1-4, wherein the resonance frequency of the antenna (730) is configured to correspond to the centre frequency of the system bandwidth in the wireless communications network (100).

6. The method according to any of claims 1-4, wherein the resonance frequency of the antenna (730) is configured to correspond to a determined frequency from of a set of determined frequencies within the system bandwidth of the wireless communications network (100).

7. The method according to any of claims 1-6, further comprising
receiving (501) information indicating that the wireless device (121) is to transmit information indicating at least one antenna characteristic to a network node (110) in the wireless communications network (100).

8. The method according to any of claims 1-7, wherein the obtaining (502) and/or the transmitting (503) is performed in response to detecting a change in at least one antenna characteristic of the antenna (730).

9. A wireless device (121) for enabling determination of transmission parameters for a transmission to a network node (110) in a wireless communications network (100), the wireless device (121) being configured to
obtain information indicating at least one antenna characteristic of an antenna (730) comprised in the wireless device (121), and transmit the information indicating the at least one antenna characteristic to a network node (110) in the wireless communications network (100).

10. The wireless device (121) according to claim 9, wherein the information indicating the at least one antenna characteristic comprise at least one of:
a parameter of the antenna (730) that indicates at least one of: a gain of the antenna (730), an impedance of the antenna (730), a radiation pattern of the antenna (730), a beam width of the antenna (730), and a polarization of the antenna (730);
a resonance frequency of the antenna (730);
a 3-dB bandwidth of the antenna (730);
a 10-dB bandwidth of the antenna (730);
a return loss parameter of the antenna (730); and
a class associated with the antenna (730).

11. The wireless device (121) according to claim 9 or 10, further configured to transmit the information as part of a connection setup procedure of the wireless device (121) in the wireless communications network (100).

12. The wireless device (121) according to claim 9 or 10, further configured to transmit the information as part of a random access procedure of the wireless device (121) in the wireless communications network (100).

13. The wireless device (121) according to any of claims 9-12, wherein the resonance frequency of the antenna (730) is configured to correspond to the centre frequency of the system bandwidth in the wireless communications network (100).

14. The wireless device (121) according to any of claims 9-12, wherein the resonance frequency of the antenna (730) is configured to correspond to a determined frequency from of a set of determined frequencies within the system bandwidth of the wireless communications network (100).

15. The wireless device (121) according to any of claims 9-14, further configured to receive information indicating that the wireless device (121) is to transmit information indicating at least one antenna characteristic to a network node (110) in the wireless communications network (100).

16. The wireless device (121) according to any of claims 9-15, further configured to obtain and/or transmit the information indicating at least one antenna characteristic in response to detecting a change in at least one antenna characteristic of the antenna (730).

17. A method performed by a network node (110) for determining transmission parameters for a transmission a wireless device (121) in a wireless communications network (100), the method comprising
obtaining (602) information indicating at least one antenna characteristic of the wireless device (121); and
performing (603) the transmission to the wireless device (121) based on the information indicating the at least one antenna characteristic of the wireless device (121).

18. The method according to claim 17, wherein the performing (603) further comprise scheduling the transmission to the wireless device (121) on at least one frequency carrier based on the information indicating the at least one antenna characteristic of the wireless device (121).

19. The method according to claim 18, further comprising determining, based on the information indicating the at least one antenna characteristic of the wireless device (121), the at least one frequency carrier such that it spans over a resonance frequency of the antenna (730).

20. The method according to claim 18, further comprising determining, based on the information indicating the at least one antenna characteristic of the wireless device (121), the at least one frequency carrier in relation to a resonance frequency of the antenna (730) such that the antenna efficiency of the antenna (730) for the transmission to the wireless device (121) is above a determined threshold.

21. The method according to any of claims 17-20, wherein the performing (603) further comprise adapting a radio link used for the transmission to the wireless device (121) based on the information indicating the at least one antenna characteristic of the wireless device (121).

22. The method according to claim 21, wherein adapting the radio link comprise selecting at least one of the following parameters for the transmission: a transmit power, a transport block size, a coding scheme, a modulation order, a precoding matrix, and a number of spatial layers.

23. The method according to any of claims 17-22, wherein the obtaining (602) comprise performing a channel estimation over the complete system bandwidth in the wireless communications network (100), and determining the at least one antenna characteristic of the wireless device (121) based on the performed channel estimation.

24. The method according to any of claims 17-22, wherein the obtaining (602) comprises retrieving the information indicating the at least one antenna characteristic of the wireless device (121) from another network node (131) in the wireless communications network (100).

25. The method according to any of claims 17-22, wherein the obtaining (602) comprise receiving the information indicating at least one antenna characteristic of the wireless device (121) from the wireless device (121).

26. The method according to any of claims 17-25, further comprising storing the information indicating the at least one antenna characteristic of the wireless device (121) via another network node (131) in the wireless communications network (100).

27. The method according to any of claims 17-26, further comprising
transmitting (601) information indicating that the wireless device (121) is to transmit information indicating at least one antenna characteristic to the wireless device (121) in the wireless communications network (100).

28. A network node (110) for determining transmission parameters for a transmission to a wireless device (121) in a wireless communications network (100), the network node (110) being configured to
obtain information indicating at least one antenna characteristic of the wireless device (121) and perform the transmission to the wireless device (121) based on the information indicating the at least one antenna characteristic of the wireless device (121).

29. The network node (110) according to claim 28, further configured to perform the transmission by scheduling the transmission to the wireless device (121) on at least one frequency carrier based on the information indicating the at least one antenna characteristic of the wireless device (121).

30. The network node (110) according to claim 29, further configured to determine, based on the information indicating the at least one antenna characteristic of the wireless device (121), the at least one frequency carrier such that it spans over a resonance frequency of the antenna (730).

31. The network node (110) according to claim 29, further configured to determine, based on the information indicating the at least one antenna characteristic of the wireless device (121), the at least one frequency carrier in relation to a resonance frequency of the antenna (730) such that the antenna efficiency of the antenna (730) for the transmission to the wireless device (121) is above a determined threshold.

32. The network node (110) according to any of claims 28-31, further configured to perform the transmission by adapting a radio link used for the transmission to the wireless device (121) based on the information indicating the at least one antenna characteristic of the wireless device (121).

33. The network node (110) according to claim 32, further configured to adapt the radio link by selecting at least one of the following parameters for the transmission: a transmit power, a transport block size, a coding scheme, a modulation order, a precoding matrix, and a number of spatial layers.

34. The network node (110) according to any of claims 28-33, further configured to obtain the information by performing a channel estimation over the complete system bandwidth in the wireless communications network (100), and determining the at least one antenna characteristic of the wireless device (121) based on the performed channel estimation.

35. The network node (110) according to any of claims 28-33, further configured to obtain the information by retrieving the information indicating the at least one antenna characteristic of the wireless device (121) from another network node (131) in the wireless communications network (100).

36. The network node (110) according to any of claims 28-33, further configured to obtain the information by receiving the information indicating at least one antenna characteristic of the wireless device (121) from the wireless device (121).

37. The network node (110) according to any of claims 28-36, further configured to store the information indicating at least one antenna characteristic of the wireless device (121) via another network node (131) in the wireless communications network (100).

38. The network node (110) according to any of claims 28-37, further configured to transmit information indicating that the wireless device (121) is to transmit information indicating the at least one antenna characteristic to the wireless device (121) in the wireless communications network (100).

39. A computer program product, comprising instructions which, when executed on at least one processor (710; 810), cause the at least one processor (710; 810) to carry out the method according to any of claim 1-8 or 17-27.

40. A carrier containing the computer program product according to claim 39, wherein the carrier is one of an electronic signal, optical signal, radio signal, or computer-readable storage medium.
